(19) United States
(12) Patent Application Publication
(10) Pub. No.: US 2010/0268923 A1
(43) Pub. Date: Oct. 21, 2010

(54) METHOD AND DEVICE FOR CONTROLLING A COMPUTER SYSTEM HAVING AT LEAST TWO GROUPS OF INTERNAL STATES

(76) Inventors: Reinhard Weiberle, Vaihingen/Enz (DE); Bernd Mueller, Leonberg-Silberberg (DE); Eberhard Boehl, Reutlingen (DE); Yorck von Collani, Beilstein (DE); Rainer Gmehlich, Ditzingen (DE)

Correspondence Address: KENYON & KENYON LLP, ONE BROADWAY, NEW YORK, NY, 10004, US

(21) Appl. No.: 12/063,192

(22) PCT Filed: Jul. 24, 2006
(86) PCT No.: PCT/EP2006/064598

§ 371 Date: Jul. 1, 2010

(30) Foreign Application Priority Data
Aug. 8, 2005 (DE) 10 2005 037 244.9

(51) Int. Cl. G06F 9/318

(52) U.S. Cl. 712/229; 712/E09.035

(57) ABSTRACT

A method and device for controlling a computer system having at least two execution units and having at least two groups of internal states, in particular processor states, in at least one of the execution units, and having a switchover device, through which it is possible to switch between at least two different operating modes, in particular a performance mode and a compare mode, of the computer system, wherein a switchover is triggered by the fact that at least one execution unit changes its internal state.

### FIELD OF THE INVENTION

The present invention relates to a device and a method for switching between at least two operating modes of a multiprocessor system having at least two execution units or CPUs as well as a corresponding processor system.

### BACKGROUND INFORMATION

Transient errors, triggered by alpha particles or cosmic radiation, are an increasing problem for integrated semiconductor circuits. Due to declining structure widths, decreasing voltages and higher clock frequencies, there is an increased probability that a voltage spike, caused by an alpha particle or by cosmic radiation, will falsify a logic value in an integrated circuit. The effect can be a false calculation result. In safety-relevant systems, especially in a motor vehicle, such errors must therefore be reliably detected.

In safety-relevant systems such as an ABS control system in a motor vehicle where malfunctions of the electronic equipment must be detected with certainty, redundancies for error detection are normally used in the corresponding control devices of such systems. Thus, for example, in known ABS systems, the complete microcontroller is duplicated in each instance, the total ABS functions being calculated redundantly and checked for consistency. If a discrepancy appears in the results, the ABS system is switched off.

A microcontroller is made up of, on the one hand, memory modules (e.g., RAM, ROM, cache), a core (CPU) and input/output interfaces, so-called peripherals (e.g., analog-digital converter, CAN interface). Since memory elements can be effectively monitored using test codes (parity or ECC), and peripherals are often monitored specific to the application as part of a sensor signal path or actuator signal path, a further redundancy approach lies in solely doubling the core of a microcontroller.

Such microcontrollers having at least two integrated cores are also referred to as dual-core architectures or multi-core architectures. Both cores execute the same program segment redundantly and in a clock-synchronized manner; the results of the two cores are compared, and an error will then be detected when the cores are compared for consistency. In the following, this configuration of a dual-core system is called compare mode.

In other applications, dual-core architectures are also used to increase performance. Both cores execute different programs, program segments or instructions, whereby an increase in output can be achieved, which is why this configuration of a dual-core system is called performance mode.

These systems can be extended by a switchover, i.e., depending on the purpose of application of the multiprocessor system, it may be operated in a compare mode or in a performance mode. In the compare mode, the output signals of the cores are compared to each other. If there is a difference, an error signal is output. In the performance mode, the two cores operate as a symmetrical multiprocessor system (SMP) and execute different programs, program segments, or instructions. In this mode, the comparator unit is not active.

So-called processor states, such as a user mode or supervisor mode, are used in many applications. It is possible then to fulfill the requirements of the application particularly well in a way that goes beyond the conventional arrangements if one additionally considers the possible operating modes of the processor system.

### SUMMARY

Example embodiments of the present invention provide devices and methods that provide a joint optimization of the processor states and of the operating modes.

A method is advantageously used for controlling a computer system having at least two execution units and having at least two groups of internal states, in particular processor states, in at least one of the execution units, and having a switchover device, through which it is possible to switch between at least two different operating modes, in particular a performance mode and a compare mode, of the computer system, wherein a switchover is triggered by the fact that at least one execution unit changes its internal state.

A method is advantageously used in which, during the change of the internal state from an old to a new state in at least one of the execution units, the new state belongs to a different group of states than the old state.

A method is advantageously used in which the execution unit, which initiates a switchover by changing its state, generates a signal that triggers the switchover of at least one additional execution unit.

A method is advantageously used in which the states are compared with stored reference values and, as a function of the comparison, switchover signals are generated.

A method is advantageously used in which the comparison takes place cyclically.

A method is advantageously used in which the comparison always takes place when a state is changed.

A method is advantageously used in which in one state of the execution units, in which state user programs are processed, the computer system is operated in a performance mode and where the switchover to the compare mode is triggered by a change of state in at least one execution unit.

A method is advantageously used in which in the user mode of the processor units (that is, in the processor state in which user programs are processed), the multiprocessor system is operated in a compare mode, and the switchover to the performance mode is triggered by a change of the processor state in at least one execution unit.

A method is advantageously used in which every state of an execution unit is assigned to at least one group of states and of the at least two groups of states, a dedicated multiprocessor operating mode, in particular a performance mode or a compare mode, is permanently assigned to at least one of these groups.

A method is advantageously used in which there are three groups of states, each state is assigned to at least one of these groups and the performance mode is assigned to one first group and the compare mode is assigned to one second group, and for a third group of processor states a switchover of the operating modes through an external signal is permitted.

A method is advantageously used in which there are three groups of states, each state is assigned to at least one of these groups and the performance mode is assigned to one first group and the compare mode is assigned to one second group, and for a third group of processor states a switchover of the operating modes through access to a particular memory address is permitted.

A method is advantageously used in which there are three groups of states, each state is assigned to at least one of these groups and the performance mode is assigned to one first group and the compare mode is assigned to one second group, and for a third group of processor states a switchover of the operating modes through the execution of a special instruction is permitted.

A method is advantageously used in which the internal state of an execution unit is indicated by at least one bit in a register of this execution unit.

A device is advantageously used for controlling a computer system having at least two execution units and having at least two groups of internal states, in particular processor states, in at least one of the execution units, and having a switchover device, through which it is possible to switch between at least two different operating modes, in particular a performance mode and a compare mode, of the computer system, wherein the switchover device is designed such that a switchover is triggered by the fact that at least one execution unit changes its internal state.

A device is advantageously used in which the switchover device is designed such that a switchover is triggered by the fact that at least one execution unit changes to another group of states.

A device is advantageously used in which a memory or memory area, in particular a register, is contained and the state is indicated by at least one bit in a register of this execution unit.

A device is advantageously used in which a device is available that compares the states of the at least two execution units to stored combinations and, as a function of the result of the comparison, generates a switchover signal for switching the operating modes of the computer system.

A device is advantageously used in which a device for storing data exists and there reference values for the combination of states are stored, in which states the operating modes should be switched.

A computer system having a device described above is advantageously used.

A computer system is advantageously used in which the execution unit that initiates a switchover by changing its state generates a signal that triggers the switchover of at least one additional execution unit.

Other features and aspects of example embodiments are described below with reference to the appended Figures.

### BRIEF DESCRIPTION OF THE DRAWINGS

FIG. 1 shows a multiprocessor system having two execution units and a switchover and comparator unit.

FIG. 2 shows a multiprocessor system having two execution units and an additional signal connection between these execution units.

FIG. 3 shows a multiprocessor system having two execution units and an additional comparator unit for comparing the information regarding processor state.

FIG. 4 shows a comparator unit for comparing information regarding processor state.

FIG. 5 shows a state diagram of a multiprocessor system having two states and four transition conditions.

FIG. 6 shows a multiprocessor system having an external switchover-request signal.

FIG. 7 shows a general switchover and comparator unit for a multiprocessor system.

### DETAILED DESCRIPTION

In the following, both a processor, a core, a CPU, as well as an FPU (floating point unit), a DSP (digital signal processor), a coprocessor or an ALU (arithmetic logical unit) may be called an execution unit.

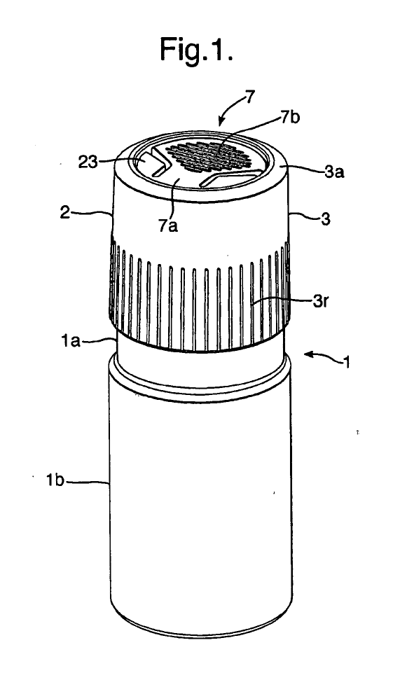

The subject matter of example embodiments of the present invention is a multiprocessor system (W100) shown in FIG. 1 having at least two execution units (W110a, W110b), one comparator unit (W120), and one switchover unit (W150). The execution units are each connected to a comparator unit (W120) and the switchover unit (W150) via an optional buffer (W111a, W111b). Switchover unit (W150) has at least two outputs to two system interfaces (W130a, W130b). Registers, memories or peripherals such as digital outputs, digital-to-analog converters and communication controllers may be controlled via these interfaces.

This multiprocessor system may be operated in at least two operating modes, a compare mode CM and a performance mode PM.

In the performance mode, different instructions, program segments or programs are executed in parallel in the different execution units. The comparator unit is deactivated in this operating mode. In this operating mode, switchover unit (W150) is configured such that each execution unit is connected via the optional buffer to one of system interfaces (W130a, W130b). A result of an execution unit may be written to a memory (W170) via the system interfaces, or it may be output to a peripheral module (W180, W190). A peripheral module may be, for example, an analog-to-digital converter or a communication controller of a communication system (e.g. SPI, LIN, CAN, FlexRay).

There are multiple possibilities for deactivating a comparator unit. First of all, it is possible to supply a signal to the comparator (for example, via the connection W125), which signal activates or deactivates the comparator. To this end, an additional logic circuit must be inserted in the comparator, which is able to perform this task. Another possibility is to supply no data to be compared to the comparator. A third possibility is to ignore the error signal (W155) of the comparator on the system level. Moreover, one may also interrupt the error signal itself. What all of the possibilities have in common is that they generate in the system a state in which it does not matter if there is a difference between two or more data that are potentially compared. If this state is reached through a measure in the comparator or its input or output signals, then the comparator is described as passive or deactivated.

In the compare mode, the same or similar instructions, program segments or programs are processed in both execution units (W110a, W110b). The output signals of the execution units are carried via optional buffers (W111a, W111b) to comparator unit (W120) and to switchover unit (W150). In the compare unit, the two data are checked for agreement. After the comparison has been carried out, the switchover unit is informed via a status signal (W125) whether this switchover unit may output one of the consistent results to one of the system interfaces or whether it must block the signal due to a detected discrepancy in the results. In this case, the comparator unit may output an optional error signal (W155). This error signal may also be output by the switchover unit (W156) instead of by the comparator unit. Comparator unit (W120) and switchover unit (W150) may also be united into a combined switchover and comparator unit (N100a).

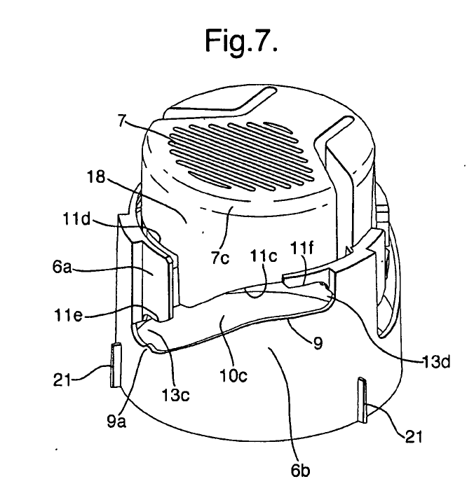

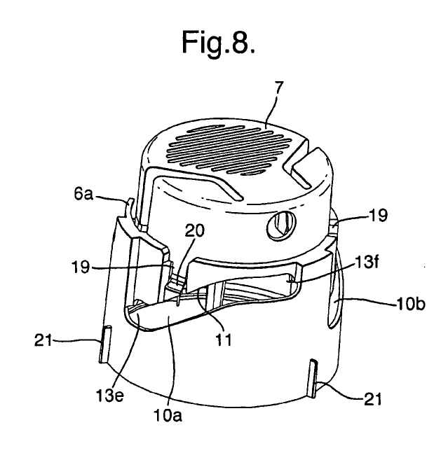

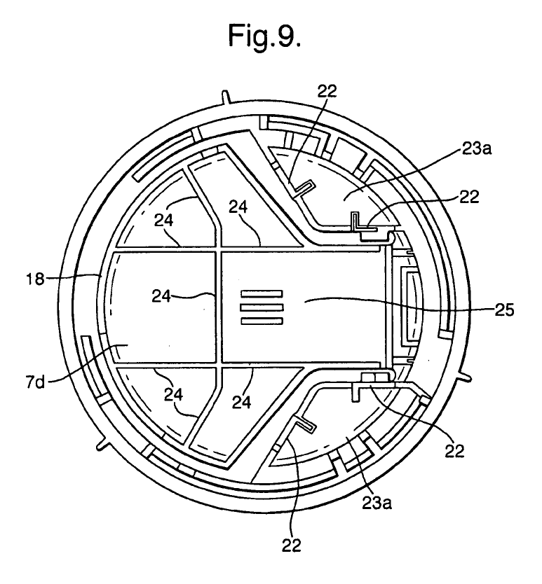

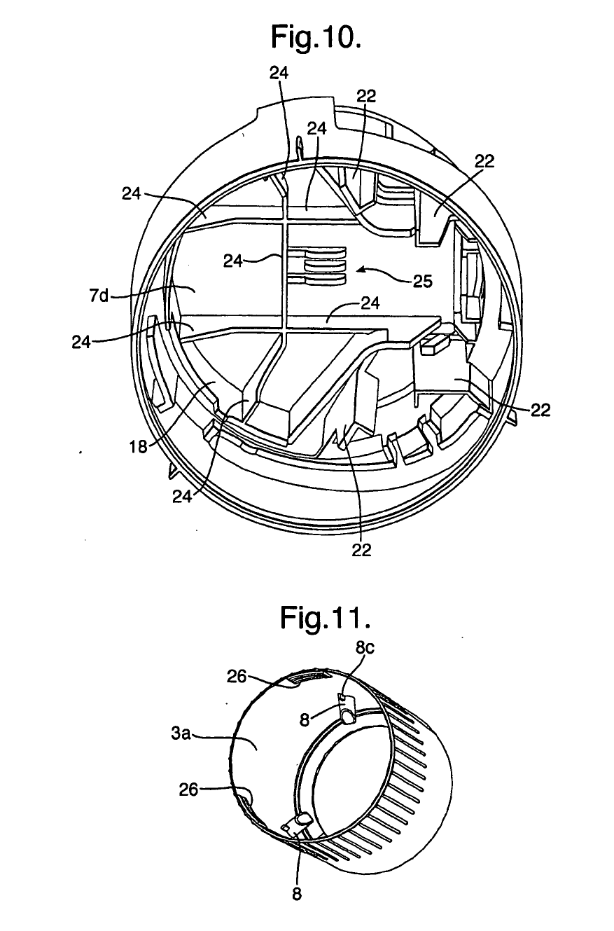

A general case of the switchover and comparator component, which may also be used for more than two execution units, is shown in FIG. 7. Of the n execution units to be considered, n signals N140, . . . , N14n are transmitted to switchover and compare component N100 (corresponds to 100a). From these input signals, this component is able to generate up to n output signals N160, . . . , N16n. In the simplest case, the “pure performance mode,” all signals N14i are routed to the corresponding output signals N16i. In the opposite limiting case, the “pure compare mode,” all signals N140, . . . , N14n are routed only to precisely one of the output signals N16i.

More than only two operating modes are possible in a system having n execution units and n>2. FIG. 7 helps illustrate how the various possible modes may be produced. To this end, this figure includes the logic component of a switching logic N110. This component does not have to exist as a separate component. What is crucial is that the functions described are realized in the system. Switching logic N110 first of all determines how many output signals there actually are. It also determines which of the input signals contribute to which of the output signals. In this context, one input signal may contribute to precisely one output signal. Formulated differently in mathematical form, the switching logic thus defines a function that assigns one element of set {N160, . . . , N16n} to each element of set {N140, . . . , N14n}.

Processing logic N120 then determines for each of the outputs N16i, in what form the inputs contribute to this output signal. This component, as well, does not necessarily need to exist as a separate component. Decisive, again, is that the described functions are implemented in the system. To describe the different possible variations by way of example, let it be assumed, without limiting the universality, that output N160 is generated by signals N141, . . . , N14m. If m=1, this simply corresponds to the signal being switched through; if m=2, then signals N141, N142 are compared. This comparison may be performed synchronously or asynchronously; it may be performed on a bit-by-bit basis, or only for significant bits or also using a tolerance range.

The configuration of the switchover and comparator unit (N100) is, depending on the priority of the system components, a function of the operating mode of the multiprocessor system or defines the operating mode. To ensure that information regarding the operating mode remains consistent within the system, and where necessary to communicate the operating mode to external units, it is advantageous to identify the information regarding the operating mode in one of the system components and, to make it available in one or more signals.

In a preferred implementation, this signal may be generated in the switchover and comparator unit, and be made available to other parts of the system as a mode signal N150. In addition, an error signal N170 is drawn into this figure. The optional error signal is generated by error circuit logic N130, which collects the error signals, and is either a direct forwarding of the individual error signals or a bundling of the error information contained therein. Mode signal N150 is optional; however, its use outside of this component may be advantageous in many places. The combination of the information of switching logic N110 (i.e., the function mentioned above) and of the processing logic (i.e., the establishment of the comparison operation per output signal, i.e., per functional value) is the mode information, and this determines the operating mode of the multiprocessor system or reflects it. Generally, this information is naturally multi-valued, i.e., not representable by only one logic bit. Not all theoretically possible modes are practical in a given implementation; preferably, the number of permitted modes will be limited. The mode signal then brings the relevant mode information to the outside. A HW implementation is preferably represented in such a way that the externally visible mode signal may be configured. Preferably the processing logic and the switching circuit logic are likewise designed to be configurable. These configurations are preferably coordinated with one another. Alternatively, one may only or additionally give changes of the mode signal to the outside, as well. This has advantages, especially in a dual configuration.

The operating modes of the multiprocessor system are coupled in some way with the processor states. This can also be formulated more precisely:

The switchover itself or the enabling of a switchover between the at least two operating modes of the multi-processor system depends on the internal processor state of at least one execution unit (for example, user mode, interrupt mode) or on the change of the internal processor state of at least one execution unit.

The type and number of possible processor states depends on the processor type. Common processor states include, for example, init mode (initialization), user mode (processor state in which most application tasks are processed), supervisor mode (for example, for reset and SW interrupt), interrupt mode (for interrupt request), abort mode (for example, for handling memory access violations) and system mode (privileged mode in which operating system instructions are processed). The current processor state is indicated by at least one bit in the processor status register or by an internal signal in the processor.

The switchover between the different processor states of the execution units occurs in this instance in, e.g., a conventional manner, by setting a bit in the processor status register, by an explicit instruction, or implicitly by the execution of particular instructions or through external or internal events (such as errors, memory access violations, reset, interrupt, SW interrupt, triggering of operating system routines).

The individual execution units of a multiprocessor system may be in different processor states at time T1 in the performance mode. In such a system, the switchover between the operating modes of the multiprocessor system may occur as a function of an internal processor state of exactly one dedicated execution unit, an internal processor state of any execution unit of the system, or a particular combination of internal processor states of at least two execution units.

If the switchover between two operating modes or the enabling of a switchover between the at least two operating modes of the multiprocessor system depends on the internal processor state or on the change of the internal processor state of exactly one execution unit, this execution unit must generate a switchover signal which triggers the switchover of the at least one additional execution unit.

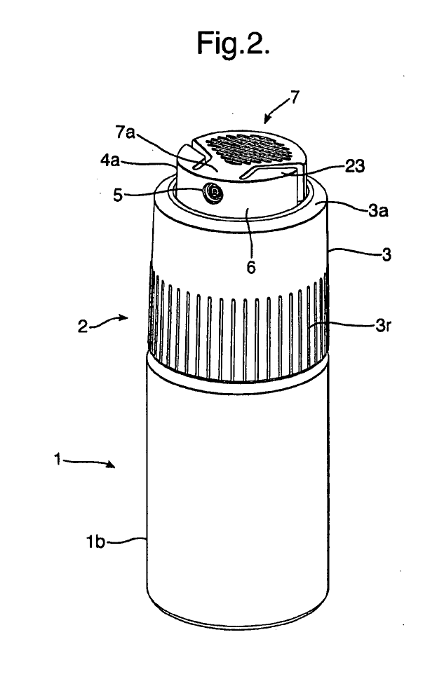

FIG. 2 shows a multiprocessor system W200 that is based on the multiprocessor system W100 shown in FIG. 1. In the example embodiment shown in FIG. 2, the multiprocessor system contains two execution units (W210a, W210b) that are each connected to a comparator unit (W220) and a switchover unit (W250) via an optional buffer (W111a, W111b). What is new compared to system W100 is the signal path W215 in system W200, via which signal path the execution unit, whose internal processor state initiates a change between the two operating modes, provides a switchover signal to the other execution unit, to comparator unit (W220), and to switchover unit (W250). As already shown in FIG. 1, here too comparator unit (W220) and switchover unit (W250) may be combined to form a switchover and comparator unit.

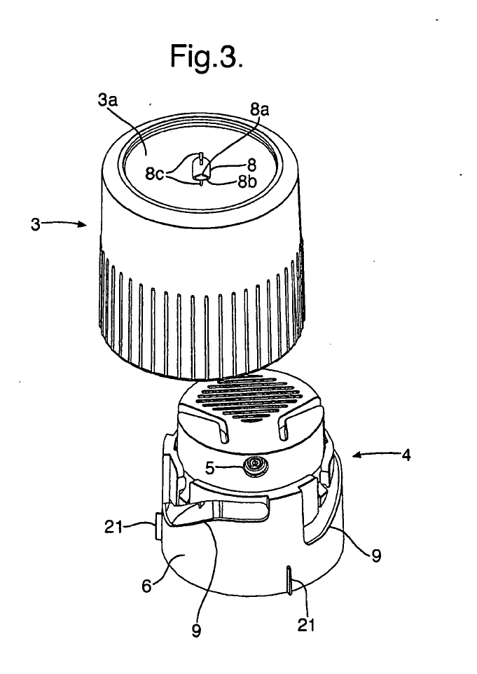

FIG. 3 shows a multiprocessor system W300 having two execution units (W310a, W310b) and an additional unit W312. FIG. 3 is based again on FIG. 1; now the changes are described. Such a system is necessary if the switchover between two operating modes takes place as a function of a particular combination of internal processor states of at least two execution units. Unit W312 reads in this instance the relevant internal processor states of the execution units or receives them from the execution units and compares the current combination of processor states with one or more stored combinations. Where consistency is found, unit W312 initiates a switchover of the operating mode and to that end sends a relevant signal to the execution units and via signal path W315 to comparator unit (W320) and to switchover unit (W350).

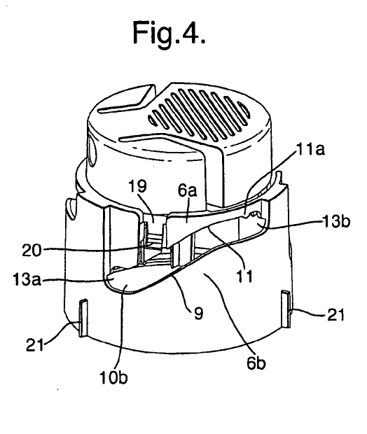

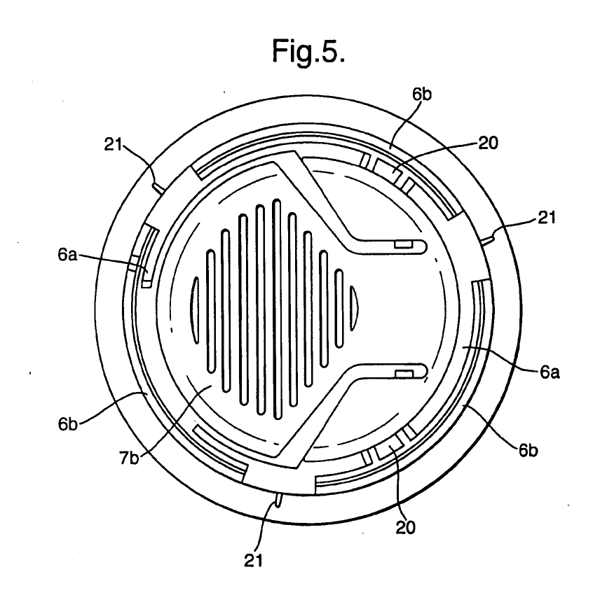

FIG. 4 shows an exemplary embodiment of the internal structure of unit W312. Particular combinations of internal processor states of the execution units are stored in a memory W313, which may be implemented for example as a register, RAM, Flash, ROM, or EEPROM, in which states the operating modes should be switched over or which states are coupled with a particular operating mode. In a comparator W314, the current processor states of the execution units are compared to the stored samples cyclically or upon request by a signal W315. If the result of the comparison is a request for a switchover, unit W314 generates a switchover signal that is sent to the execution units and via signal path W315 to the comparator unit and to the switchover unit.

In the system according to example embodiments of the present invention, the internal processor states of at least one execution unit are divided into at least two groups P1 and P2 and/or the combinations of the processor states are divided into at least two groups PZ1 and PZ2. In a preferred exemplary embodiment a dedicated operating mode (that is, a specific performance mode or compare mode) may be assigned to at least one of these groups of processor states or processor state combinations.

FIG. 5 shows a state diagram of an exemplary system having the two operating modes W510 and W520. In this system, there are four transition conditions W511, W512, W521 and W522. In this context, the transition conditions W512 and W521 cause the operating mode to change; the transition conditions W511 and W522 cause the system to remain in the current operating mode.

In a first exemplary embodiment, transition conditions W511, W512, W521, W522 depend solely on the processor state of a first execution unit and the operating modes of the processor system. Table 1 presents a transition matrix for the exemplary case that the processor states of group P1 are coupled with operating mode W510 and the processor states of group P2 are coupled with operating mode W520. In this exemplary embodiment, every processor state of a first execution unit is assigned to a group P1 or P2. The processor states of the second and if applicable additional execution units are not utilized in this instance as switchover conditions. This exemplary embodiment may also be modified such that instead of a processor state of a dedicated execution unit, the processor state of any execution unit is utilized as a switchover condition.

In a second exemplary embodiment, transition conditions W511-W522 depend solely on the combinations of the internal processor states and the operating modes of the processor system. Table 2 presents a transition matrix for the exemplary case that the processor state combinations of group PZ1 are coupled with operating mode W510 and the processor state combinations of group PZ2 are coupled with operating mode W520. In this exemplary embodiment, every combination of states of the at least two execution units is assigned to a group PZ1 or PZ2.

In a third exemplary embodiment, the switchover between the operating modes depends on the processor state of a first execution unit. The possible processor states of this execution unit are divided into three groups P1, P2, and P3. A first operating mode is assigned permanently to the processor states of group P1; a second operating mode is assigned to the processor states of group P2, and in optional group P3 of processor states, a switchover between the operating modes (for example, triggered by an external signal) is permitted. Thus, every processor state of a first execution unit belongs to exactly one group P1, P2, or P3. The processor states of the second and if applicable additional execution units are not utilized in this instance as switchover conditions. This exemplary embodiment may also be modified such that instead of a processor state of a dedicated execution unit, the processor state of any execution unit is utilized as a switchover condition.

In a fourth exemplary embodiment, a first operating mode is assigned permanently to the processor state combinations of group PZ1; a second operating mode is assigned to the processor state combinations of group PZ2, and in an optional group PZ3 of processor state combinations, a switchover between the operating modes (for example, triggered by an external signal) is permitted. Thus every processor state combination belongs to exactly one group PZ1, PZ2, or PZ3: In the system, there is no processor state combination that does not belong to one of these groups.

The four exemplary embodiments described may also be extended to the effect that the respective processor states or processor state combinations do not cause a direct switchover, but rather only an enabling of a switchover. The switchover itself is then carried out either via an external signal, controlled by software, or—as conventional—initiated by accessing special memory areas. What is characteristic in this instance is that these switchover requests are implemented only if the switchover was previously enabled as a function of the processor states or processor state combinations.

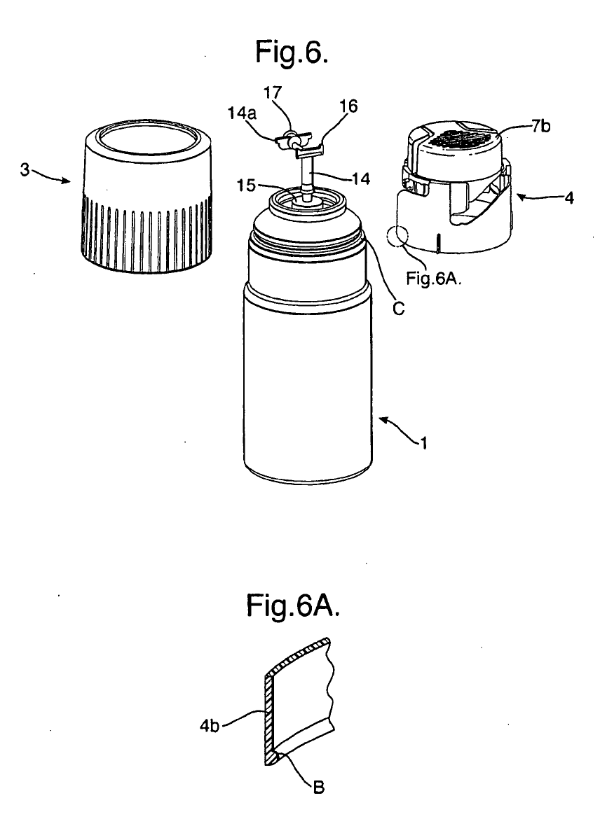

FIG. 6 describes the switchover via an external signal and is based again on FIG. 1. Only the changes are described. An external signal W160 that derives from an external signal source W140 is added to the overall system, which is labeled W101 here.

In an illustrative exemplary embodiment, the user mode of at least one execution unit is coupled with the performance mode. In the compare mode, the multiprocessor system is operated solely in connection with the init mode (during start up), and/or the supervisor mode (during SW interrupts and resets), and/or the abort mode. In the compare mode, however, all execution units must assume the same processor state. The synchronization of processor states thus takes place when the operating mode of the multiprocessor system is switched. This switchover takes place in this instance as a function of at least one bit or a bit pattern of the processor status word of at least one execution unit, which indicates a processor state of this execution unit.

In an additional illustrative exemplary embodiment, the user mode is coupled with the compare mode. The multiprocessor system is switched to the performance mode to be able to more quickly process a special job only in connection with at least one dedicated processor state (for example, init mode and/or supervisor mode and/or abort mode).

In an additional exemplary embodiment, a switchover between the operating modes is in general only permitted if at least one execution unit is in a privileged processor state (for example, supervisor mode). For safety reasons, it may also be provided that a switchover is permitted only if all execution units are in a privileged mode. After the switchover has been enabled, the switchover itself may then take place via a method shown in the exemplary embodiments described above, via external switchover signal W160 shown in FIG. 6, controlled by software or when an execution unit accesses special memory areas.

1 to 20. (canceled)

21. A method for controlling a computer system having at least two execution units and having at least two groups of at least one of (a) internal states and (b) processor states in at least one of the execution units, and having a switchover device, comprising:
switching, using the switchover device, between at least two different operating modes, including a performance mode and a compare mode, of the computer system;
wherein a switchover is triggered by at least one execution unit changing an internal state.

22. The method according to claim 21, wherein during the change of the internal state from an old to a new state in at least one of the execution units, the new state belongs to a different group of states than the old state.

23. The method according to claim 21, wherein the execution unit, which initiates a switchover by changing its state, generates a signal that triggers the switchover of at least one additional execution unit.

24. The method according to claim 21, wherein the states are compared to stored reference values and switchover signals are generated as a function of the comparison.

25. The method according to claim 24, wherein the comparison is performed cyclically.

26. The method according to claim 24, wherein the comparison always takes place when a state is changed.

27. The method according to claim 21, wherein in one state of the execution units, in which state user programs are processed, the computer system is operated in a performance mode and that the switchover to the compare mode is triggered by a change of the state in at least one execution unit.

28. The method according to claim 21, wherein in a user mode of the processor units in the processor state in which user programs are processed, the system is operated in a compare mode and the switchover to the performance mode is triggered by a change of the processor state in at least one execution unit.

29. The method according to claim 21, wherein every state of an execution unit is assigned to at least one group of states and a dedicated multi-processor operating mode, including one of (a) a performance mode and (b) a compare mode, is permanently assigned to at least one of these two groups.

30. The method according to claim 29, wherein there are three groups of states, each state is assigned to at least one of the groups and the performance mode is assigned to at least one first group and the compare mode to at least one second group, and for a third group of processor states a switchover of the operating modes through an external signal is permitted.

31. The method according to claim 29, wherein there are three groups of states, each state is assigned to at least one of the groups and the performance mode is assigned to at least one first group and the compare mode to at least one second group, and for a third group of processor states a switchover of the operating modes by access to a particular memory address is permitted.

32. The method according to claim 29, wherein there are three groups of states, each state is assigned to at least one of the groups and the performance mode is assigned to at least one first group and the compare mode to at least one second group, and for a third group of processor states a switchover of the operating modes by executing a special instruction is permitted.

33. The method according to claim 21, wherein the internal state of an execution unit is indicated by at least one bit in a register of the execution unit.

34. A device for controlling a computer system having at least two execution units and having at least two groups of at least one of (a) internal states and (b) processor states in at least one of the execution units, comprising:
a switchover device configured to switch between at least two different operating modes, including a performance mode and a compare mode, of the computer system;
wherein the switchover device is configured such that a switchover is triggered by at least one execution unit changing an internal state.

35. The device according to claim 34, wherein the switchover device is configured such that a switchover is triggered by at least one execution unit changing to another group of states.

36. The device according to claim 34, further comprising at least one of (a) a memory, (b) a memory area, and (c) a register, wherein the state is indicated by at least one bit in a register of the execution unit.

37. The device according to claim 34, further comprising an arrangement configured to compare the states of the at least two execution units with stored combinations and, depending on a result of the comparison, to generate a switchover signal for switching the operating modes of the computer system.

38. The device according to claim 34, further comprising an arrangement configured to store data, including reference values for a combination of states, in which states the operating modes are switchable.

39. A computer system, comprising:
at least two execution units and having at least two groups of at least one of (a) internal states and (b) processor states in at least one of the execution units;
a device configured to control the computer system including a switchover device configured to switch between at least two different operating modes, including a performance mode and a compare mode, of the computer system;
wherein the switchover device is configured such that a switchover is triggered by at least one execution unit changing an internal state.

40. The computer system according to claim 39, wherein the execution unit, which is configured to initiate a switchover by changing state, is configured to generate a signal that triggers the switchover of at least one additional execution unit.
